(19) United States
(12) Patent Application Publication
(10) Pub. No.: US 2009/0087268 A1
(43) Pub. Date: Apr. 2, 2009

(54) Tool Holder System

(75) Inventors: Hans Schäfer, Gomaringen (DE); Heinz Thurau, Mossingen (DE)

Correspondence Address: Roylance Abrams Berdo & Goodman, 1300 19th Street NW Suite 600, Washington, DC, 20036, US

(73) Assignee: Hartmetall-Werkzeugfabrik Paul Horn GMBH, Tubingen (DE)

(21) Appl. No.: 11/920,633

(22) PCT Filed: May 16, 2006
(86) PCT No.: PCT/EP2006/004577

§ 371 Date: Nov. 19, 2007

(30) Foreign Application Priority Data
May 31, 2005 (DE) 10 2005 024 746.6

(51) Int. Cl. B23P 15/28

(52) U.S. Cl. 407/101

(57) ABSTRACT

In a tool holder system having a base support plate (1), from which a locating part (3) extends in the direction of a holder axis (5) for connection to a machine tool, in particular, a lathe, having a tool support plate (9), to which a cutting tool (43) can be attached via an intermediate piece (35), and having an adjustable guide (11) for setting the position of the two plates (1 and 9) relative to one another, the intermediate piece (35) laterally adjoins the tool support plate (9) and extends along both plates (1) and (9).

The invention relates to a tool holder system, having a base support plate, from which a receiving part extends in the direction of the holder axis for connection to a machine tool, in particular a lathe, with a tool support plate to which a cutting tool can be attached via an intermediate piece, and with an adjustable guide for setting the relative position of the two plates to one another.

Tool holder systems of this type are known and are commercially available for example under the designation “vertically adjustable rotary holder”. By means of the adjustable guide which in these tool holder systems enables relative motion between the base support plate and tool support plate over an adjustment range of approximately 1 mm or less, in these tool holder systems vertical correction can be carried out in order to equalize tool tolerances or to undertake the required correction in regrinding on the pertinent cutting tool.

The object of the present invention is to make available a tool holder system of the indicated type which is especially versatile. According to the invention, this object is achieved by a tool holder system which has the features of claim 1 in its entirety.

In that, as specified in the characterizing part of claim 1, the intermediate piece which forms the actual tool support extends laterally along the tool support plate and the base support plate, it is possible to achieve a system configuration which is optimum for the desired application with the fundamental structure of the supporting base remaining the same for the cutting tool, that is, with the construction of the base support plate with a receiving part and adjustable guidance for the tool support plate remaining the same, by simply the intermediate piece located on the tool support plate being made differently, in a manner specific to the application.

Thus, by choosing the extension of the intermediate piece which is measured transversely to the holder axis, the desired offset of the cutting edge of the cutting tool relative to the holder axis can be easily achieved. Since the intermediate piece directly adjoins the tool support plate, preferably is integral with it, compactness and high stiffness of the system are ensured.

The lengthwise position of the cutting tool which is referenced to the holder axis can be chosen in an equally simple manner by the lengthwise extension of the intermediate piece, measured parallel to the holder axis, being selected accordingly. Preferably the intermediate piece on the tool support plate extends at least to its end which is opposite the base support plate, but, relative to the holder axis, can provide a greater distance between the cutting tool and the receiving part, and can also be extended beyond the end opposite the base support plate.

The corresponding applies to the end of the intermediate piece which faces the receiving part and which can be lengthened beyond the end of the base support plate which adjoins the receiving part.

Such an elongated design of the intermediate piece is especially advantageous when an elongated cutting tool holder is to be held on the intermediate piece, for example in the manner in which there is a guide in the intermediate piece for the cutting tool holder which can be clamped and adjusted lengthwise in the direction parallel to the holder axis and which is guided positively therein.

When the adjustable guide for vertical correction between the base support plate and tool support plate has a set screw, the arrangement can advantageously be such that the screw head of the set screw is countersunk in an end widening of the associated threaded hole in the base support plate. This yields an especially compact, space-saving design without adjusting means which project over the plate body.

The invention will be detailed below using exemplary embodiments shown in the drawings.

FIG. 1 shows a perspective oblique view of one embodiment of the tool holder system according to the invention;

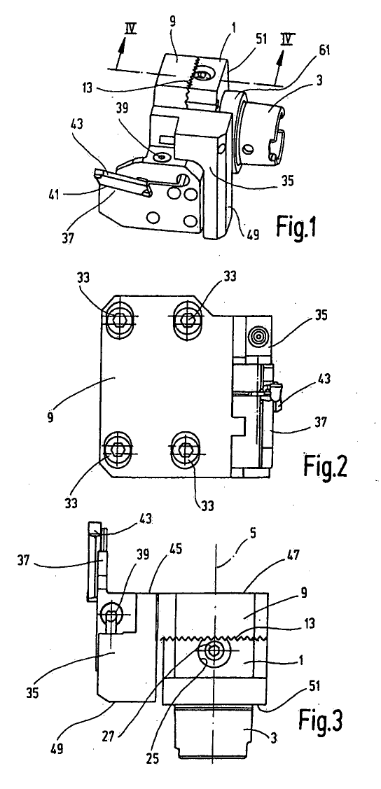

FIG. 2 shows a front view of the embodiment from FIG. 1 on a scale larger than FIG. 1;

FIG. 3 shows a top view of one embodiment;

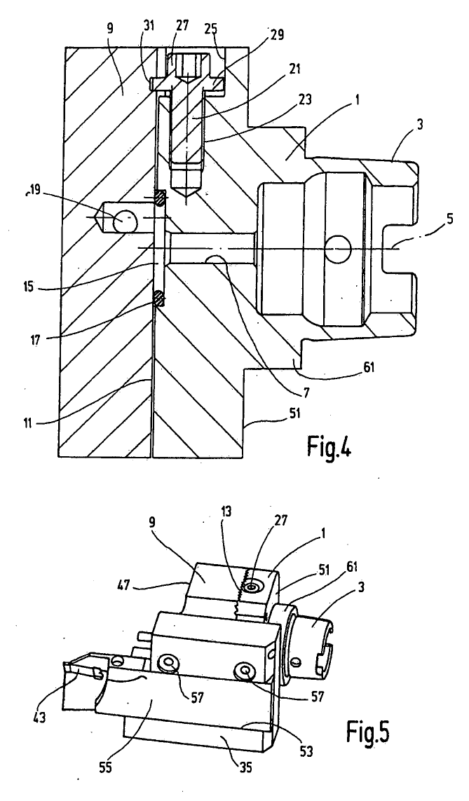

FIG. 4 shows a cross section of the embodiment from FIG. 1 drawn on a larger scale, according to the cutting line IV-IV from FIG. 1, and

FIG. 5 shows a perspective oblique view of another embodiment similar to FIG. 1.

FIG. 1 shows one embodiment of the tool holder system according to the invention in the form of a so-called vertically adjustable rotary holder. The main components of this system are the base support plate 1 with a more or less rectangular outline, on one of the wide sides of which a receiving part 3 is molded on in one piece and defines a holder axis 5 (FIGS. 3 and 4). The receiving part 3 is a standardized connecting part which is used for connection to the machine tool (hollow shaft DIN 69893 [German Industrial Standard 69893]) with internal coolant supply via a channel 7 (FIG. 4) which is concentric to the axis 5 in the base support plate 1. On the wide side facing away from the receiving part 3 the base support plate 1 for the tool support plate 9 adjoining it forms an adjustable guide 11 with parallel guide grooves, which is formed by guide toothing 13.

FIG. 4 shows greater details of the inner elements of the base support plate 1 and tool support plate 9, specifically the end widening 15 of the coolant channel 7, the sealing of this widening 15 relative to the tool support plate 9 by means of an O-ring seal 17, and a connecting channel 19 in the tool support plate, through which coolant feed is continued to the region of the cutting tool in the conventional manner (not shown). The positioning means for the adjustable guide 11 is a set screw 21 which sits in the threaded hole 23 of the base support plate 1, the screw axis running parallel to the adjustable guide 11. In the unthreaded end section the hole 23 of the base support plate 1 has a widening 25 in which the head 27 of the screw 21 is completely countersunk. In this example it is an Allen screw with a collar 29 which borders the head 27. The hole 23 in the base support plate 1 is located so narrowly adjacent to the adjustable guide 11, and thus the tool support plate 9, that the end hole widening 25 is open towards the tool support plate 9. The latter has a driver depression 31 which is engaged by the edge of the collar 29 of the set screw 21. As is to be seen, rotary motion of the set screw 21 therefore leads to an adjustment motion on the guide 11, that is, adjustment of the relative position of the plates 1 and 9 to one another.

As is to be seen from FIG. 2, the setting of the position of the plates 1 and 9 to one another can be fixed by means of four clamping screws 33 which in the corner regions of the tool support plate 9 penetrate the lengthwise holes of the latter, the heads of the clamping screws 33, in accordance with the set screw 21, likewise being countersunk in end widenings of the lengthwise holes in the tool support plate 9.

As is most clearly illustrated in FIGS. 1 and 3, an intermediate piece 35 is molded laterally on the tool support plate 9. This piece has a block shape with a more or less rectangular outline in a top view (FIG. 3), except for the projecting tool holder part 37. The tool holder part 37 forms a receiving cassette 41 which can be clamped by a tightening screw 39 for a cutting tip 43. FIGS. 1 and 3 show examples in which the intermediate piece 35 extends laterally along the plates 1 and 9 such that the back end 45 of the intermediate piece 35 which faces away from the receiving part 3 is flush with the corresponding end 47 of the tool support plate 9. In the example of FIG. 3, the other end 49 of the intermediate piece 35 extends essentially to the end 51 of the base support plate 1 which has the receiving part 3, while in the example from FIG. 1 this end 49 projects beyond the end 51 of the base support plate 1 next to the receiving part 3.

FIG. 5 shows one example in which the intermediate piece 35 is made elongated so that it projects axially over the end 51 of the plate 1 and the end 47 of the plate 9 (relative to the holder axis 5). The intermediate piece 35 can therefore be used to form an elongated, dovetail-like guide 53 for positive guidance of an elongated tool holder 55 which can be moved lengthwise therein, for the cutting tip 43, wedges 57 with countersunk screws being used to clamp the guide 53.

As already mentioned above, the base support plate 1 has the shape of a body which is for the most part rectangular in outline, as is especially apparent from FIGS. 3 and 4, the receiving part 3 centrally located being molded on the wide side of the plate which forms the end 51 so that the holder axis 5 which is defined by the hollow shaft of the receiving part 3 extends through the central region of the plate 1. As is to be seen most clearly from FIG. 4, the receiving part 3 undergoes transition on the outside over a larger diameter than the ring body 61 which has the receiving part 3 into the flat end surface of the plate 1 on its end 51.

As FIG. 1 and especially FIG. 3 clearly show in a top view, the intermediate piece 35 which is made in the shape of a block with an outline which is likewise rectangular in a top view and on the end 49 facing the receiving part 3 and on the end 45 opposite thereto likewise has a planar, rectangular end surface, is made relatively thick in the direction measured transversely to the holder axis 5. In other words, the thickness of the intermediate piece 35 measured perpendicular to the holder axis 5 is at least half the thickness of the base support plate 1 and tool support plate 9 measured in this direction. According to this dimension of the intermediate piece 35 and the arrangement of the tool holder part 37 in the region of the outside of the intermediate piece 35 away from the holder axis 5, a comparatively large axial distance between the cutting tip 43 and the holder axis 5 can be achieved.

As is to be seen in FIGS. 3 and 5, the length of the intermediate piece 35 measured in the direction parallel to the holder axis 5 is at least approximately as large as the combined extension of plates 9 and 1 measured in the corresponding direction. In the example of FIG. 3, the end 45 of the intermediate piece 35 is flush with the flat end surface of the tool support plate 9 on its end 47, while the other end 49 of the intermediate piece 35 has only a short distance to the plane of the plate 1 on its end 51.

The adjustable guide 11 forms guide grooves which run in the guide direction on the base support plate 1 and the tool support plate 9 and which are formed by the aforementioned toothing 13 which in the manner which is conventional for these guide teeth has the form of a plurality of depressions and elevations which run parallel.

As is to be seen in FIG. 4, there are two regions without teeth on the guide 11. On the one hand, this is the region of the widening 15 where the coolant channel 7 of the base support plate 1 undergoes transition into the channel 19 in the tool support plate 9. On the other hand, the tool support plate 9 in the region of the widening 25 of the hole 23 of the base support plate 1 is without teeth, but in this region there is a depression 31 which is machined into the end surface of the plate 9 and which is engaged by the collar 29 of the set screw 21.

1. Tool holder system, having a base support plate (1), from which a receiving part (3) extends in the direction of the holder axis (5) for connection to a machine tool, in particular a lathe, with a tool support plate (9) to which a cutting tool (43) can be attached by way of an intermediate piece (35), and with an adjustable guide (11) for setting the relative position of the two plates (1 and 9) to one another, wherein the intermediate piece (35) is laterally connected to the tool support plate (9) and extends along the two plates (1 and 9).

2. The tool holder system according to claim 1, wherein the intermediate piece (35) on the tool support plate (9) extends at least to its end (47) which is opposite the base support plate (11).

3. The tool holder system according to claim 1, wherein the intermediate piece (35) extends beyond the end (47) of the tool support plate (9) which is opposite the base support plate (1) in the direction parallel to the holder axis (5).

4. The tool holder system according to claim 1, wherein the intermediate piece (35) extends at least into the vicinity of the end (51) of the base support plate (1) which is connected to the receiving part (3).

5. The tool holder system according to claim 1, wherein the intermediate piece (35) extends beyond the end (51) of the base support plate (1) which is connected to the receiving part (3) in the direction parallel to the holder axis (5).

6. The tool holder system according to claim 1, wherein the adjustable guide (11) has a set screw (21) which sits in the base support plate (1), with a screw head (27) which is countersunk in an end widening (25) of the associated threaded hole (23) in the base support plate (1).

7. The tool holder system according to claim 6, wherein the set screw is a collar screw (21).

8. The tool holder system according to claim 7, wherein the hole (23) which runs in the adjustment direction of the adjustable guide (11) in the base support plate (1) is adjacent to the adjustable guide (11) such that the end widening (25) of the hole (23) on the guide (11) is open toward the tool support plate (9) and the collar (29) of the set screw (21) engages the driver depression (31) of the tool support plate (9).

9. The tool holder system according to claim 1, wherein the intermediate piece (35) has a clamping device (39, 41; 57) for a cutting tool (43) or a tool holder (55).

10. The tool holder system according to claim 9, wherein the clamping device has a guide (53) for a cutting tool holder (55) which can be clamped and adjusted lengthwise in the direction parallel to the holder axis (5) and which is guided positively therein.
